(19) United States
(12) Patent Application Publication
(10) Pub. No.: US 2011/0100546 A1
(43) Pub. Date: May 5, 2011

(54) METHOD OF FORMING A LIQUID CRYSTAL LAYER, METHOD OF MANUFACTURING A LIQUID CRYSTAL DISPLAY PANEL USING THE METHOD, AND LIQUID CRYSTAL MATERIAL USED IN THE METHOD

(75) Inventors: Dae-Hwan JANG, Suwon-si (KR); Gug-Rae JO, Asan-si (KR); Hong-Suk YOO, Anyang-si (KR); Chang-Hoon KIM, Asan-si (KR); Min-Uk KIM, Seongnam-si (KR); Joo-Han BAE, Suwon-si (KR); Bo-Kyoung AHN, Incheon (KR)

(73) Assignee: Samsung Electronics Co., Ltd., Suwon-si (KR)

(21) Appl. No.: 12/773,483

(22) Filed: May 4, 2010

(30) Foreign Application Priority Data
Nov. 4, 2009 (KR) 10-2009-0105748

(51) Int. Cl. B32B 38/14; B05D 5/12; C09K 19/00

(52) U.S. Cl. 156/277; 427/58; 252/299.01

(57) ABSTRACT

A liquid crystal layer is formed by coating a liquid crystal material having a reciprocal (Z⁻¹) of an Ohnesorge number in a range of 4≦Z⁻¹≦14 by an ink-jet printing method. The reciprocal (Z⁻¹) of the Ohnesorge number is a dimensionless number defined as Z⁻¹=([σρL]^{1/2})/μ.

### PRIORITY STATEMENT

This application claims priority from and the benefit of Korean Patent Application No. 10-2009-0105748, filed on Nov. 4, 2009, which is hereby incorporated by reference for all purposes as if full set forth herein.

### BACKGROUND OF THE INVENTION

1. Field of the Invention

Exemplary embodiments of the present invention relate to a method of forming a liquid crystal layer, a method of manufacturing a liquid crystal panel using the method, and a liquid crystal material used in the method.

2. Description of the Related Art

A conventional liquid crystal display (LCD) device includes a lower substrate, an upper substrate, and a liquid crystal layer disposed between the lower substrate and the upper substrate. A pixel electrode is formed on the lower substrate, and a common electrode is formed on the upper substrate. When a voltage is applied to the pixel electrode and the common electrode, an arrangement of liquid crystal molecules of the liquid crystal layer changes and the optical transmittance of the liquid crystal layer varies in accordance with the changed arrangement of the liquid crystal molecules to display an image.

Examples of a method for disposing the liquid crystal material between the lower substrate and the upper substrate include an injecting method and a dropping method.

There are problems with the injecting method. For example, more liquid crystal material than an intended amount may be supplied to a cell gap between the lower substrate and the upper substrate, and an additional process for cleaning the LCD panel smeared with the oversupplied liquid crystal material may be necessary.

There are also problems with the dropping method. For example, a size of a droplet of the liquid crystal material dropped on a substrate may be too large, and the dropped liquid crystal material may irregularly spread. Therefore, a boundary between adjacent droplets of the liquid crystal material may be perceived, which causes a stain to appear in the liquid crystal layer. Accordingly, a baking process for removing the stain of the liquid crystal layer may be necessary in the dropping method, and thus the process for disposing the liquid crystal material is complicated.

A spray method has been proposed to solve the problems of the dropping method, i.e., to prevent stains from appearing. However, it is hard to control a size or a volume of the droplet of the liquid crystal material in the spray method, and it is hard to control a drop position of the droplet. Therefore, it is hard to form a liquid crystal layer having a regular thickness using the spray method.

### SUMMARY OF THE INVENTION

Exemplary embodiments of the present invention provide a method of forming a liquid crystal layer for removing a stain and forming a liquid crystal layer having a regular thickness.

Exemplary embodiments of the present invention also provide a method of manufacturing a liquid crystal panel using the method of forming the liquid crystal layer.

Exemplary embodiments of the present invention also provide a liquid crystal used in the method.

Additional features of the invention will be set forth in the description which follows, and in part will be apparent from the description, or may be learned by practice of the invention.

An exemplary embodiment of the present invention discloses a method of forming a liquid crystal layer in which a liquid crystal layer is formed by coating a liquid crystal having a reciprocal (Z⁻¹) of an Ohnesorge number in a range of 4≦Z⁻¹≦14 by an ink-jet printing method. The reciprocal (Z⁻¹) of the Ohnesorge number is a dimensionless number defined as Z⁻¹=([σρL]^{1/2})/μ. The σ represents a coefficient of a surface tension of the liquid crystal material, which has units of Newtons per meter (N/m), and the ρ represents a density of the liquid crystal material, which has units of kilograms (kg/m³). The L represents a diameter of a liquid crystal material droplet formed in the ink-jet printing method, which has units of meters (m). The μ represents a coefficient of a viscosity of the liquid crystal material, which has units of Pascal-seconds (Pa·s).

An exemplary embodiment of the present invention also discloses a method of manufacturing a liquid crystal panel in which a liquid crystal material having a reciprocal (Z⁻¹) of an Ohnesorge number in a range of 4≦Z⁻¹≦14 is coated on a first substrate by an ink-jet printing method, combining the first substrate and a second substrate.

An exemplary embodiment of the present invention also discloses a liquid crystal material used as a raw material for forming a liquid crystal layer by an ink-jet printing method has a reciprocal (Z⁻¹) of an Ohnesorge number in a range of 4≦Z⁻¹≦14.

An exemplary embodiment of the present invention also discloses an apparatus for ink-jet printing a liquid crystal material onto a substrate, the apparatus including a container to contain the liquid crystal material; an ink-jet head including a nozzle from which the liquid crystal material is ejected onto the substrate; a supply line disposed between the container and the ink-jet head so as to deliver the liquid crystal material from the container to the ink-jet head; a stage on which the substrate is disposed to receive the liquid crystal material ejected from the nozzle of the ink-jet head; and a controller to control a temperature of the liquid crystal material disposed at least one of the container, the supply line, the ink-jet head, and the stage.

According to aspects of the present invention, a stain may be prevented from appearing in the liquid crystal layer without an additional process, such as a baking process. Furthermore, the position at which the liquid crystal droplet is settled on the substrate may be easily controlled, and a positional error of the droplet may be reduced. Therefore, a uniform liquid crystal layer may be formed.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an ink-jet coating apparatus for performing a method of forming a liquid crystal layer in accordance with an exemplary embodiment of the present invention.

FIG. 2 is a cross-sectional view illustrating a liquid crystal display (LCD) panel including a liquid crystal layer formed by the ink-jet coating apparatus illustrated in FIG. 1.

FIG. 3A, FIG. 3B, and FIG. 3C are illustrations showing dropping shapes of the droplet of liquid crystal material taken according to time.

FIG. 4 is a graph showing a positional error of the liquid crystal material droplet measured according to the reciprocal (Z⁻¹) of the Ohnesorge number.

FIG. 5A is a graph showing positional errors of the liquid crystal material droplets measured when the reciprocal (Z⁻¹) of the Ohnesorge number of the liquid crystal material is no more than 14.

FIG. 5B is a graph showing positional errors of the liquid crystal material droplets measured when the reciprocal (Z⁻¹) of the Ohnesorge number of the liquid crystal material is more than 14.

FIG. 6A, FIG. 6B, and FIG. 6C are cross-sectional views describing a method of manufacturing an LCD panel using the method of forming the liquid crystal layer described with reference to FIG. 1 and FIG. 2.

FIG. 7 is a cross-sectional view describing a method of manufacturing an LCD panel in accordance with another exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will be thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on,” “connected to” or “coupled to” another element or layer, it can be directly on, directly connected to, or directly coupled to the other element or layer or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the invention. As such, variations from the shapes of the illustrations as a result, for example, of manufacturing techniques and/or tolerances, are to be expected. Thus, exemplary embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from an implanted to a non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosure.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be explained in detail with reference to the accompanying drawings.

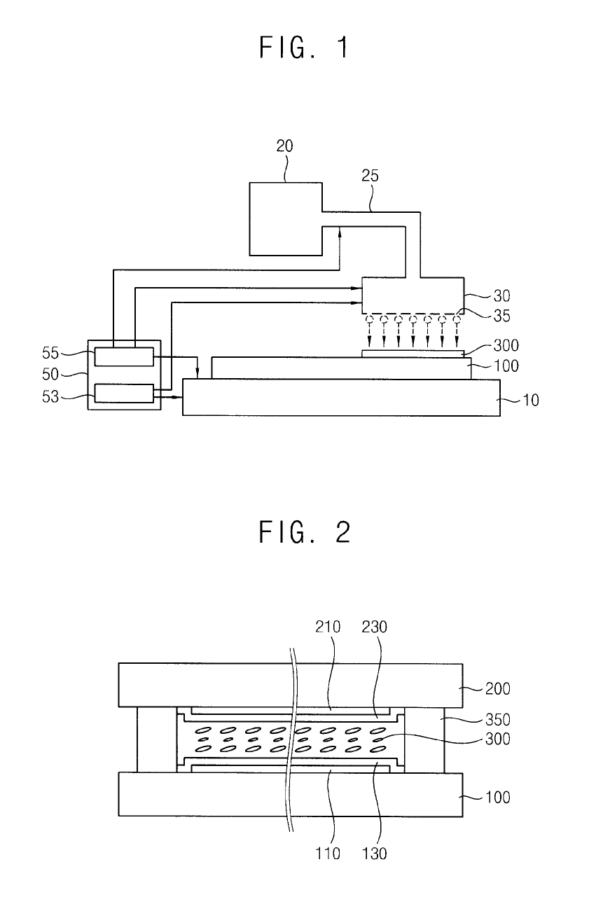

FIG. 1 is a block diagram illustrating an ink-jet coating apparatus that performs a method of forming a liquid crystal layer in accordance with an exemplary embodiment of the invention. FIG. 2 is a cross-sectional view illustrating a liquid crystal display (LCD) panel including a liquid crystal layer formed by the ink-jet coating apparatus illustrated in FIG. 1.

Referring to FIG. 1 and FIG. 2, an LCD panel includes a first substrate 100, a second substrate 200 facing the first substrate 100, and a liquid crystal layer 300 disposed between the first substrate 100 and the second substrate 200.

The first substrate 100 may include a pixel electrode 110. The second substrate 200 may include a common electrode 210 facing the pixel electrode 110. The pixel electrode 110 receives a pixel voltage, and the common electrode 210 receives a common voltage. When the pixel voltage and the common voltage are applied to the pixel electrode 110 and the common electrode 210, respectively, an electric field is generated between the pixel electrode 110 and the common electrode 210. An arrangement of liquid crystal molecules of the liquid crystal layer 300 is changed by the electric field, and the optical transmittance of the liquid crystal material is adjusted in accordance with the changed arrangement of the liquid crystal molecules to display an image.

The LCD panel including the liquid crystal layer 300 may include alignment layers 130 and 230 for aligning the liquid crystal molecules. The LCD panel may include a seal line 350 for sealing the liquid crystal material of the liquid crystal layer 300. However, a structure of the LCD panel described in FIG. 2 is merely one example, and the method of forming a liquid crystal layer in accordance with the invention is not limited to the LCD panel having the structure described in FIG. 2. For example, the common electrode 210 may be not formed on the second substrate 200, but may be formed on the first substrate 100. Although not illustrated in FIG. 2, the LCD panel may further include a switching element, a plurality of wires, a color filter, an insulation layer, a driving circuit, etc.

The method of forming a liquid crystal layer in accordance with the present invention is applied for forming the liquid crystal layer 300 of the LCD panel. Particularly, according to the present exemplary embodiment, the liquid crystal material is coated on one of the first substrate 100 and the second substrate 200 by an ink-jet printing method. Although the liquid crystal material is coated on the first substrate 100 in FIG. 1, aspects of the invention are not limited thereto. That is, the liquid crystal material may be coated on the second substrate 200 in another exemplary embodiment.

The ink-jet coating apparatus includes a stage 10, a liquid crystal material container 20, a supply line 25, an ink-jet head 30, and a controller 50.

The first substrate 100 on which liquid crystal material from the liquid crystal material container 20 is to be coated is loaded onto the stage 10. However, as described above, aspects are not limited thereto such that the second substrate 200 may be loaded onto the stage 10.

In order to dispose a droplet of the liquid crystal material on an intended position of the substrate 100, the stage 10 may move in a first direction or in a second direction, the first and second directions being in a plane parallel to a plane of the stage 10 on which the substrate 100 is disposed. Alternatively, the stage 10 is fixed, and the ink-jet head 30 may move in the first direction or in the second direction. Although described as the first or the second directions, aspects are not limited thereto such that the stage 10 and/or the ink-jet head 30 may be moved in both the first and the second directions independently and/or simultaneously. Further, the first and second directions may be perpendicular to each other.

The liquid crystal material container 20 stores the liquid crystal material. The supply line 25 delivers the liquid crystal material from the liquid crystal material container 20 to the ink-jet head 30. When a plurality of liquid crystal material containers 20 is used, a plurality of supply lines 25 may be connected to the plurality of liquid crystal material containers 20, respectively. Alternatively, a single supply line 25 may be connected to each of the plurality of liquid crystal material containers 20.

The ink-jet head 30 includes a plurality of nozzles 35. The nozzles 35 may be arranged on the ink-jet head 30 in any arrangement suitable for ink-jet printing the liquid crystal material. For example, the nozzles 35 may be arranged in a row, rows, a matrix, matrices, a column, columns, or combinations thereof. The liquid crystal material delivered by the supply line 25 are ejected through the nozzles 35 of the ink-jet head 30, and are coated on the substrate 100 disposed on the stage 10. In order to dispose a droplet of the liquid crystal material at an intended position of the substrate 100, the ink-jet head 30 may move in the first direction or in the second direction as described above, i.e., the first and second directions being in a plane parallel to a plane of the stage 10 on which the substrate 100 is disposed. Alternatively, the ink-jet head 30 is fixed, and the stage 10 may move in the first direction or in the second direction. Although a size of the ink-jet head 30 shown in FIG. 1 is smaller than a length or a width of the substrate 100, aspects are not limited thereto such that the size of the ink-jet head 30 may be substantially the same as the length or the width of the substrate 100. When the size of the ink-jet head 30 is substantially the same as that of the substrate 100, the liquid crystal material may be coated on the substrate 100 by one scan. Accordingly, a processing time may be reduced.

Although not illustrated in FIG. 1, a heater may be included in the liquid crystal material container 20 and/or the supply line 25 to increase a temperature of the liquid crystal material. The heater may be used to control the temperature of the liquid crystal material, which affects factors, such as a viscosity, a density, a surface tension, etc., of the liquid crystal material. The heater may be also installed on the stage 10 and/or the ink-jet head 30. The heater of the stage 10 may be used to control a temperature of the substrate 100 while coating the substrate 100 with the liquid crystal material. The heater of the ink-jet head 30 may be used to control a temperature of the liquid crystal material being ejected from the nozzles 35 of the ink-jet head 30 while coating the substrate 100 with the liquid crystal material.

The controller 50 may include a driving controller 53 and a temperature controller 55. Arrows shown in FIG. 1 indicate elements that may be controlled by the driving controller 53 and the temperature controller 55. For example, the driving controller 53 may control a movement of the stage 10 or a movement of the ink-jet head 30 to adjust relative positions between the ink-jet head 30 and the substrate 100 loaded onto the stage 10. The temperature controller 55 may control a temperature of at least one of the liquid crystal material container 20, the supply line 25, the ink-jet head 30, and the stage 10.

According to aspects of the invention, the liquid crystal material is coated on the substrate 100 by an ink-jet printing method.

In a conventional dropping method, such as a one drop filling (ODF) method, an interval between droplets of dropped liquid crystal material is large, and a spreading extent of the liquid crystal droplet varies according to the position of the droplet. Thus, a position of the droplet of the liquid crystal material after an assembling process may be different from a dropping position of the liquid crystal in a dropping process. Therefore, a stain may appear at an inside of the droplet of the liquid crystal or at a boundary between the droplets. Further, since a liquid crystal having a high viscosity is not well spread, it is difficult to apply the liquid crystal material having a high viscosity in the ODF method. Furthermore, when the viscosity of the liquid crystal material is low or a gap between two substrates of the LCD panel is narrow, an active unfilled area (AUA) defect may occur. The AUA defect represents a defect in that the liquid crystal material is not filled to an edge or in a corner of the LCD panel.

According to aspects of the present invention, the liquid crystal material is coated on the substrate 100 by the ink-jet printing method, which prevents the staining of the liquid crystal layer. In order to coat the substrate 100 with the liquid crystal material by the ink-jet printing method according to aspects of the invention, the liquid crystal material should have properties suitable to the ink-jet printing method. Examples of properties that may affect a formation of the droplet of the liquid crystal material include a viscosity, a density, a surface tension, etc. In order to describe a property of the liquid crystal material, an Ohnesorge number (Z), which is a dimensionless number comprising a combination of a viscosity, a density, a surface tension, and a size of a droplet of the liquid crystal, is used.

The liquid crystal in accordance with aspects of the invention is used as a raw material for forming the liquid crystal layer by the ink-jet printing method. A reciprocal (Z⁻¹) of the Ohnesorge number of the liquid crystal material in accordance with aspects of the invention is in a range of 4≦Z¹≦14. The reciprocal (Z⁻¹) of the Ohnesorge number is a dimensionless number defined as Z⁻¹=([σρL]^{1/2})/μ. “σ” represents a coefficient of a surface tension of the liquid crystal material droplet, which has units of Newtons per meter (N/m), and “ρ” represents a density of the liquid crystal material droplet, which has units of kilograms per cubic meter (kg/m³). “L” represents a diameter of the liquid crystal material droplet, which has units of meters (m), and “μ” represents a coefficient of a viscosity of the liquid crystal material droplet, which has units of Pascal-seconds (Pa·s).

The reciprocal (Z⁻¹) of the Ohnesorge number of the liquid crystal material droplet is an index for determining whether the property of the liquid crystal material is suitable to the ink-jet printing method. Hereinafter, the reasons why the reciprocal (Z⁻¹) of the Ohnesorge number is in a range of 4≦Z⁻¹≦14 will be explained.

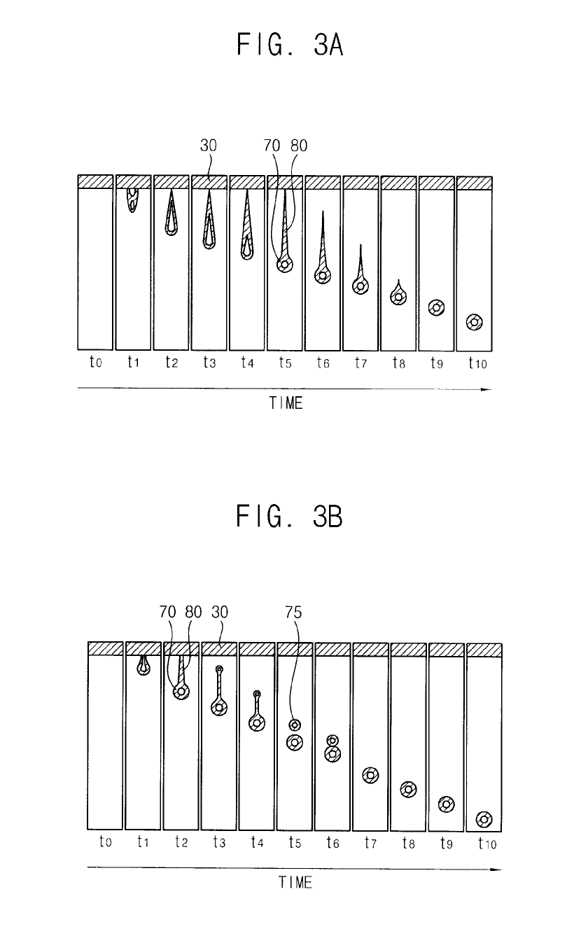

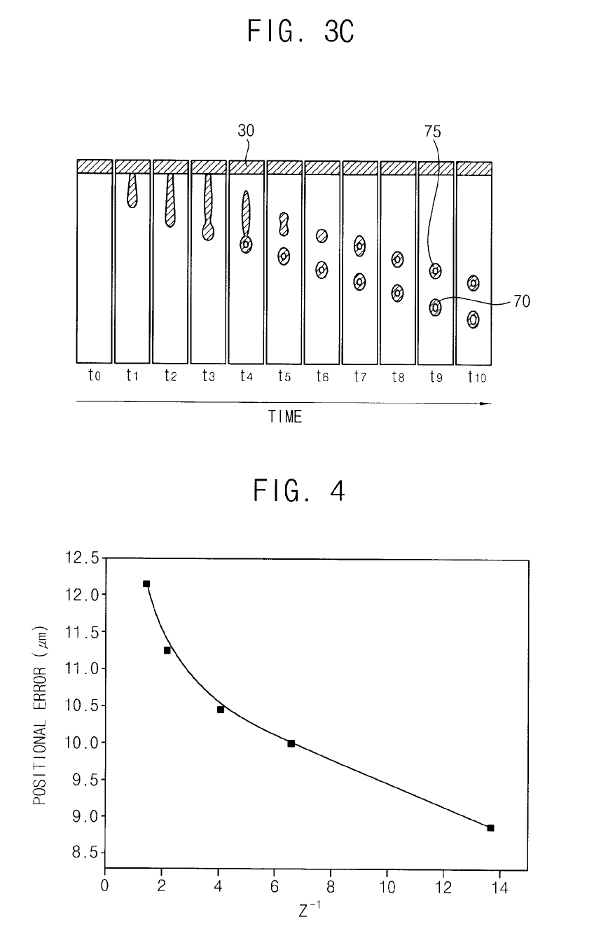

FIG. 3A, FIG. 3B, and FIG. 3C are illustrations showing dropping shapes of droplets of liquid crystal taken according to time. The illustrations of the droplets in each figure are successively taken at a regular interval during the same time (i.e., from time t₀ to time t₁₀), and are arranged in the time order. For example, FIG. 3A illustrates dropping shapes of the droplet of liquid crystal material successively taken at a regular interval when the reciprocal (Z⁻¹) of the Ohnesorge number of the liquid crystal is 2.17, and the pictures are arranged in chronological order from the time t₀ to the time t₁₀. FIG. 3B illustrates dropping shapes of the droplet of liquid crystal material successively taken at a regular interval when the reciprocal (Z⁻¹) of the Ohnesorge number of the liquid crystal material is 6.57, and the pictures are arranged in chronological order from the time t₀ to the time t₁₀. FIG. 3C illustrates dropping shapes of the droplet of liquid crystal material successively taken at a regular interval when the reciprocal (Z⁻¹) of the Ohnesorge number of the liquid crystal is 17.32, and the pictures are arranged in chronological order from the time t₀ to the time t₁₀.

As shown in FIG. 3A, FIG. 3B, and FIG. 3C, the formation mechanism of the droplet of liquid crystal material varies according to the reciprocal (Z⁻¹) of the Ohnesorge number of the liquid crystal.

Referring to FIG. 3A, when the reciprocal (Z⁻¹) of the Ohnesorge number is 2.17, i.e., is less than 4, a filament 80 is formed at a tail of a main droplet 70 of the dropping liquid crystal material that is ejected from the nozzle of the ink-jet head 30. Specifically, when the reciprocal (Z⁻¹) of the Ohnesorge number is less than 4, the filament 80 formed when dropping the liquid crystal material is relatively long. When the long filament 80 is formed at the tail of the droplet, it may be impossible to perform an ink-jet printing at a high speed (i.e., at high scanning frequency). Further, since a distance at which the droplet, i.e., the main droplet 70 and the long filament 80, separates from the ink-jet head 30 is increased when the long filament 80 is formed at the tail of the main droplet 70, a distance between the nozzles 35 of the ink-jet head 30 and the substrate, i.e., the first or second substrate 100 or 200, should be increased. When the nozzle of the ink-jet head 30 and the substrate 100 or 200 is increased, relative positions of the ink-jet head 30 and the substrate 100 or 200 are changed much during falling of the droplet. Accordingly, the droplet of liquid crystal material may be dropped on a position of the substrate 100 or 200 that is not an intended position. Therefore, occurrence of a positional error of the dropped droplet may be increased.

Referring to FIG. 3B, when the reciprocal (Z⁻¹) of the Ohnesorge number is 6.57, i.e., in a range of 4 to 14, a filament 80 is formed at a tail of the main droplet 70 of the dropping liquid crystal material that is ejected from the nozzles 35 of the ink-jet head 30, but the filament 80 is relatively short so that it may be possible to perform an ink-jet printing at a high speed. Moreover, since a distance between the nozzles 35 of the ink-jet head 30 and the substrate 100 or 200 is reduced, the droplet of liquid crystal material may be dropped at an intended position, and a rate of a positional error of the dropped droplet may be reduced.

When the reciprocal (Z⁻¹) of the Ohnesorge number is in the range of 4 to 14, the filament 80 is broken during falling of the droplet. Accordingly, a satellite droplet 75 in addition to the main droplet 70 is temporarily produced (i.e., between time t₅ to time t₆). However, the satellite droplet 75 is recombined with the main droplet 70 soon after formation (i.e., at time t₇) so ultimately no additional droplet is produced.

Referring to FIG. 3C, when the reciprocal (Z⁻¹) of the Ohnesorge number is 17.32, i.e., more than 14, at least one satellite droplet 75 in addition to the main droplet 70 is produced, and the satellite droplet 75 does not recombine with the main droplet 70 (i.e., two droplets are formed between time t₅ to time t₁₀ and remain separate). Specifically, the satellite droplet 75 is dropped at an unexpected position beside the main droplet 70, which is dropped at an intended position. Therefore, the droplet of the liquid crystal material is not dropped at the intended position when the reciprocal (Z⁻¹) of the Ohnesorge number is more than 14, and a rate of a positional error of the droplet may be considerably increased because of the satellite droplet 75 that remains separate from the main droplet 70.

The behavior of the liquid crystal droplets varying according to the reciprocal (Z⁻¹) of the Ohnesorge number may be explainable as follows.

The difference of the behavior of the liquid crystal droplet, which varies according to the reciprocal (Z⁻¹) of the Ohnesorge number, is caused by a difference of the surface tension of the liquid crystal material and caused by a difference of a velocity between a front portion and a rear portion of the liquid crystal droplet.

As the coefficient of the surface tension increases, a surface area of the material is decreased to reduce surface energy. For example, as the coefficient of the surface tension of the liquid crystal droplet increases, the liquid crystal droplet is broken faster to reduce the total surface area of the resultant droplets, i.e., the resultant droplets have a lower surface energy than the elongated droplet having a tail or filament. The coefficient of the surface tension is one factor of the numerator of the reciprocal (Z⁻¹) of the Ohnesorge number. Thus, as the reciprocal (Z⁻¹) of the Ohnesorge number increases, the liquid crystal droplet tends to be broken faster.

The velocity of the droplet depends on the viscosity of the liquid crystal material at end portions of the nozzles 35. For example, energy delivered to the liquid crystal droplet from the end portions of the nozzles 35 is consumed to form a new surface area, and remaining energy is changed to kinetic energy of the liquid crystal droplet. As the viscosity of the liquid crystal droplet increases, more energy is consumed to form the new surface area, and the kinetic energy of the liquid crystal droplet decreases. That is, as the viscosity of the liquid crystal droplet increases, the velocity of the front portion of the main droplet 70 may decrease. The viscosity is one factor of a denominator of the reciprocal (Z⁻¹) of the Ohnesorge number. Thus, as the reciprocal (Z⁻¹) of the Ohnesorge number decreases, the velocity of the front portion of the droplet may decrease.

When the reciprocal (Z⁻¹) of the Ohnesorge number is less than 4, the velocity of the rear portion of the droplet (i.e., the portion corresponding to the filament 80) is higher than that of the front portion of the droplet (i.e., the portion corresponding to the main droplet 70), so that the rear portion of the droplet may overtake the front portion of the droplet. Therefore, the filament may be not broken, i.e., the satellite droplet 75 may not be formed.

When the reciprocal (Z⁻¹) of the Ohnesorge number is in the range of 4 to 14, though the filament extending from the ejected droplet is broken due to the surface tension, the velocity of the rear portion of the droplet is sufficient to recombine with the main droplet 70. Specifically, the rear portion of the droplet broken during falling, i.e., the satellite droplet 75, recombines with the main droplet 70, so that an additional droplet ultimately is not produced. Therefore, the liquid crystal whose reciprocal (Z⁻¹) of the Ohnesorge number is in the range of 4 to 14 is suitable to be coated at an intended position on the substrate 100 or 200.

When the reciprocal (Z⁻¹) of the Ohnesorge number is more than 14, the filament extending from the ejected droplet is broken due to the surface tension. In this case, since the velocity of the front portion of the droplet is higher than that of the rear portion of the droplet, i.e., the velocity of the main droplet 70 is greater than the velocity of the satellite droplet 75, the broken portion of the droplet may not recombine with the main droplet 70. Accordingly, an additional droplet in addition to the main droplet is ultimately formed on the substrate 100 or 200, i.e., at least one or more satellite droplets 75 are produced. As mentioned above, when the liquid crystal droplet ejected from the nozzle of the ink-jet head 35 is broken into at least two droplets, i.e., the main droplet 70 and the satellite droplet 75, there is an additional droplet disposed at an unexpected position beside a droplet dropped at an intended position. Therefore, the droplet of the liquid crystal material is not dropped at the intended position, and a rate of a positional error of the droplet may be considerably increased due to the additional droplet that remains separate from the main droplet 70.

FIG. 4 is a graph showing a positional error of the liquid crystal droplet measured according to the reciprocal (Z⁻¹) of the Ohnesorge number. In FIG. 4, a horizontal axis represents the reciprocal (Z⁻¹) of the Ohnesorge number, and a vertical axis represents a total positioning error (D) calculated from positioning error values measured during a process of coating a substrate, i.e., the substrate 100 or 200, with the liquid crystal material by an ink-jet printing method according to aspects of the invention.

The total positioning error (D) is determined by a combination of an error generated by a distance between the substrate 100 or 200 and the ink-jet nozzle 35 (hereinafter, such error will referred to as “a stand-off distance error”), an error generated by bending of the droplet during ejection, and a positional error generated by a relative positional error between the substrate 100 or 200 and the ink-jet nozzle 35 which is caused by the ink-jet printing apparatus itself (hereinafter, “a mechanical positional error”)

The total positioning error (D) is defined as D=[A²+B²C²]^{1/2}. The “A” represents the stand-off distance error, which depends upon a distance (hereinafter, “a stand-off distance”) between the substrate 100 or 200 and the ink-jet nozzle 35. The “B” represents a positional error caused by bending of the droplet during ejection, and the “C” represents the mechanical positional error.

The droplet flies from the ink-jet nozzle 35 to the substrate 100 or 200 after ejection. For the instant that the droplet is ejected from the ink-jet nozzle 35, the stage 10 onto which the substrate 100 or 200 is loaded may be moved, or the ink-jet nozzle 35 may be moved. Accordingly, the movement of the stage 10 relative to the ink-jet nozzle 35 may result in an error occurring during the flight of the droplet, and such error determines the stand-off distance error (A). The positional error (B) caused by bending of the droplet is determined by a bending angle of the droplet and the stand-off distance. The bending angle at the nozzle was set at ±0.95. The mechanical positional error (C) was ±5 μm, which is a conventional value. The total positioning error (D) was measured and calculated at a minimum stand-off distance (for example, 500 μm) for the ink-jet printing and at a jetting frequency of 1 kHz.

According to the graph in FIG. 4, the positional error was about 12.1 μm when the reciprocal (Z⁻¹) of the Ohnesorge number was 1.42, and the positional error was about 11.2 μm when the reciprocal (Z⁻¹) of the Ohnesorge number was 2.17. The positional error was about 10.5 μm when the reciprocal (Z⁻¹) of the Ohnesorge number was 4.08, and the positional error was about 10.0 μm when the reciprocal (Z⁻¹) of the Ohnesorge number was 6.57. The positional error was about 8.9 μm when the reciprocal (Z⁻¹) of the Ohnesorge number was 13.58. Specifically, when the reciprocal (Z⁻¹) of the Ohnesorge number is no more than 14, the positional error decreases as the reciprocal (Z⁻¹) of the Ohnesorge number increases. Particularly, when the reciprocal (Z⁻¹) of the Ohnesorge number is less than 4, the positional error is exponentially reduced according to the increase of the reciprocal (Z⁻¹) of the Ohnesorge number. In other words, differences in the positional error are large when the reciprocal (Z⁻¹) of the Ohnesorge number is less than 4. However, when the reciprocal (Z⁻¹) of the Ohnesorge number is no less than 4, the differences in the positional error are gradually reduced, and the positional error is generally linearly reduced until the reciprocal (Z⁻¹) of the Ohnesorge number is 14. Therefore, it may be appreciated that the larger the reciprocal (Z⁻¹) of the Ohnesorge number of the liquid crystal material is, the better to reduce the positional error. Particularly, it is preferred that the reciprocal (Z⁻¹) of the Ohnesorge number of the liquid crystal is the same or more than 4.

It is noted that the graph in FIG. 4 shows data of the positional error when the reciprocal (Z⁻¹) of the Ohnesorge number of the liquid crystal is no more than 14. As mentioned above, when the reciprocal (Z⁻¹) of the Ohnesorge number is more than 14, at least one or more satellite droplets 75 in addition to the main droplet 70 are produced. When the liquid crystal droplet ejected from the nozzle 35 of the ink-jet head 30 separates into more than two droplets and does not rejoin, there is an additional droplet dropped at an unexpected position in addition to a droplet dropped at an intended position. Therefore, the droplet of the liquid crystal is not dropped at the intended position, and a rate of the positional error of the droplet may be considerably increased due to the additional droplet. Thus, when the reciprocal (Z⁻¹) of the Ohnesorge number of the liquid crystal is more than 14, definite data of the positional error is not measured or determined.

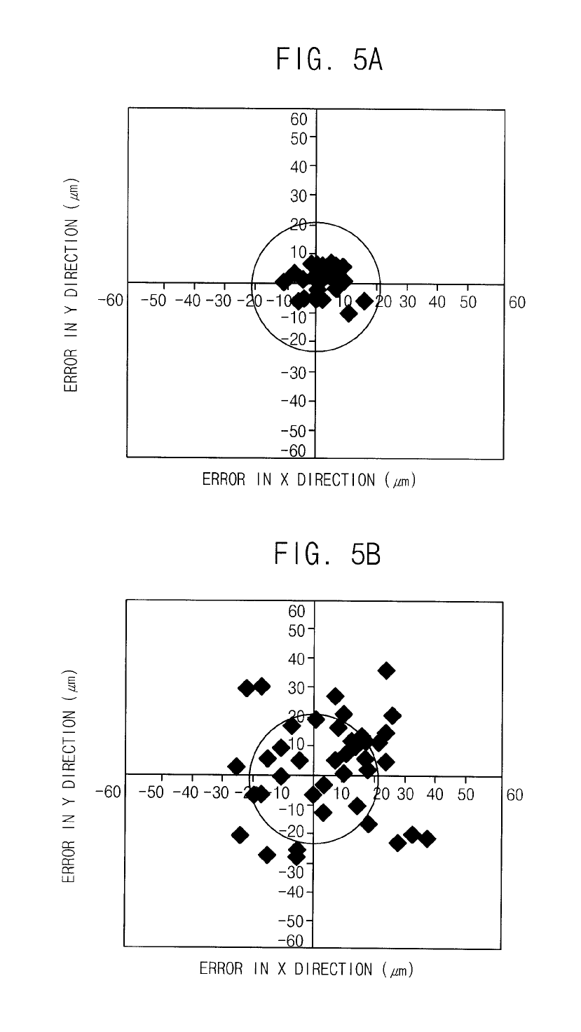

FIG. 5A is a graph showing positional errors of the liquid crystal droplets measured when the reciprocal (Z⁻¹) of the Ohnesorge number of the liquid crystal is no more than 14. FIG. 5B is a graph showing positional errors of the liquid crystal droplets measured when the reciprocal (Z⁻¹) of the Ohnesorge number of the liquid crystal is more than 14.

In FIG. 5A and FIG. 5B, a horizontal axis represents a positional error in an “x” direction with respect to an origin, or intended location of the droplet on the substrate, and a vertical axis represents a positional error in a “y” direction with respect to the origin. Specifically, FIG. 5A and FIG. 5B are graphs representing a top view of a substrate on which the liquid crystal material having reciprocals (Z⁻¹) of the Ohnesorge numbers no more than and more than 14, respectively. Further, the distances in the x and y directions represent the distance from the origin of the drops of the liquid crystal material. The circle shown in each figure has a radius of about 20 μm and is centered at the origin.

A distance between a substrate and an ink-jet nozzle was fixed at 500 μm, and a plurality of liquid crystal droplets having the reciprocal (Z⁻¹) of the Ohnesorge number less and more than 14 were coated on the substrate at an interval of 300 μm. Then, one droplet of the dropped droplets was selected as a reference droplet, and distances for each droplet to the reference droplet were calculated.

Referring to FIG. 5A, when the reciprocal (Z⁻¹) of the Ohnesorge number of the liquid crystal material is no more than 14 (for example, Z⁻¹=13.58), all the positional errors of the droplets were no more than 20 μm from the reference drop, and an average of the positional errors was about 4.91 μm from the reference drop. Specifically, it is appreciated that the droplets of the liquid crystal material are precisely settled at an intended position when the reciprocal (Z⁻¹) of the Ohnesorge number of the liquid crystal is no more than 14.

In contrast, referring to FIG. 5B, when the reciprocal (Z⁻¹) of the Ohnesorge number of the liquid crystal is more than 14 (for example, Z⁻¹=17), the number of droplets having a positional error more than 20 μm from the reference drop is large, and an average of the positional errors was about 20.18 μm from the reference drop, which is relatively high. Furthermore, it was found that a number of droplets in the case described in FIG. 5B was more than that of droplets described in FIG. 5A in the same sample area, which means that additional satellite droplets in addition to the main droplets were settled at unexpected positions. As a result, when the reciprocal (Z⁻¹) of the Ohnesorge number of the liquid crystal is more than 14, the liquid crystal material is not coated at an intended position on the substrate.

When the liquid crystal droplet is settled at an unexpected position, a stain may appear in a liquid crystal layer because adjacent droplets overlap with each other or spreading lengths of the droplets are different from a designed value. Therefore, when the reciprocal (Z⁻¹) of the Ohnesorge number of the liquid crystal material is no more than 4 or more than 14, stains in the liquid crystal layer may be present. Therefore, the reciprocal (Z⁻¹) of the Ohnesorge number of the liquid crystal used in the ink-jet printing method should be in a range of 4≦Z⁻¹≦14.

The reciprocal (Z⁻¹) of the Ohnesorge number of the liquid crystal may be controlled by adjusting a temperature of the liquid crystal material during the ink-jet printing.

Table 1 shows that the reciprocal (Z⁻¹) of the Ohnesorge number of three kinds of liquid crystal materials varies according to the temperature. For each sample of liquid crystal described in Table 1, the diameter of the liquid crystal droplet ejected from the ink-jet nozzle was 50 μm, and the velocity of the liquid crystal droplet was set at 3 m/s.

TABLE 1

| | | | | surface | reciprocal (Z⁻¹) |
|---|---|---|---|---|---|
| | temper- | density | viscosity | tension | of the |
| | ature | (ρ) | (μ) | (σ) | Ohnesorge |
| | [° C.] | [kg/m³] | [Pa · s] | [N/m] | number |
| liquid | 20 | 1093 | 17 × 10⁻³ | 31 × 10⁻³ | 2.4 |
| crystal | 25 | 1089 | 14 × 10⁻³ | 30 × 10⁻³ | 2.9 |
| sample 1 | 40 | 1077 | 8 × 10⁻³ | 28 × 10⁻³ | 4.9 |
| liquid | 20 | 1172 | 16.1 × 10⁻³ | 56.2 × 10⁻³ | 3.6 |
| crystal | 40 | 1154 | 10.1 × 10⁻³ | 53.7 × 10⁻³ | 5.5 |
| sample 2 | 20 | 1088 | 10.2 × 10⁻³ | 49.5 × 10⁻³ | 5.1 |
| liquid | 25 | 1083 | 8.1 × 10⁻³ | 49 × 10⁻³ | 6.4 |
| crystal | 40 | 1068 | 3.7 × 10⁻³ | 47.8 × 10⁻³ | 13.7 |
| sample 3 | 45 | 1061 | 3.3 × 10⁻³ | 47.7 × 10⁻³ | 15.5 |

Referring to Table 1, as the temperatures of the liquid crystal samples 1, 2, and 3 used in the experiment of forming a liquid crystal layer were increased, all of the densities, the viscosities, and the coefficients of the surface tension decreased. Since the reciprocal (Z⁻¹) of the Ohnesorge number is defined as Z⁻¹=([σρL]^{1/2})/μ, the reciprocal (Z⁻¹) of the Ohnesorge number was increased, though all of the densities, the viscosities, and the coefficients of the surface tension were decreased.

The reciprocal (Z⁻¹) of the Ohnesorge number of the liquid crystal sample 1 was no less than 4 at a temperature above of 35° C. The reciprocal (Z⁻¹) of the Ohnesorge number of the liquid crystal sample 2 was no less than 4 at a temperature above of 25° C. The maximum temperature of the liquid crystal sample 1 and the liquid crystal sample 2 should be set so that the reciprocal (Z⁻¹) of the Ohnesorge number is no more than 14. Further, since the liquid crystal may degrade at high temperature, the temperature of the liquid crystal may be less than 150° C.

The reciprocal (Z⁻¹) of the Ohnesorge number of the liquid crystal sample 3 was no less than 4 at a room temperature, and was more than 14 a temperature above of 40° C. Accordingly, when the liquid crystal sample 3 is used as a raw material for forming a liquid crystal layer by the ink-jet printing method in accordance with aspects of the invention, the temperature of the liquid crystal ejected from the ink-jet nozzle should be in a range of 20° C. to 40° C.

Furthermore, it is appreciated that the liquid crystal sample 3 has properties suitable to apply the method of forming the liquid crystal layer according to aspects of the invention at a low temperature compared to the liquid crystal sample 1. Accordingly, aspects of the invention may not only provide a method capable of preventing a stain from appearing without an additional process, such as a baking process, and capable of forming a uniform liquid crystal layer, but also provide a liquid crystal material suitable to the method.

Although processing conditions for forming the liquid crystal layer may be changed according to the property of the liquid crystal material, the optimum processing condition in accordance with aspects of the invention may be found. For example, in an exemplary embodiment using the liquid crystal sample 3 as a raw material for forming the liquid crystal layer, the temperature of the liquid crystal may be set in a range of 20° C. to 40° C. In such case, the coefficient of surface tension (σ) of the liquid crystal is in a range of 47.8×10⁻³ N/m to 49.5×10⁻³ N/m, and the density (ρ) is in a range of 1,068 kg/m³ to 1,088 kg/m³. The coefficient of viscosity (μ) is in a range of 3.3×10⁻³ Pa·s to 10.2×10⁻³ Pa·s. The reciprocal (Z⁻¹) of the Ohnesorge number calculated from the factors is in a range of 5.1 to 13.7.

Similarly to the method of forming a liquid crystal layer, when the liquid crystal layer is formed by the ink-jet printing method with the liquid crystal having a reciprocal (Z⁻¹) of the Ohnesorge number in a range of 4≦Z¹≦14, a stain may be prevented from appearing in the liquid crystal layer without an additional process, such as a baking process. Furthermore, the position where the liquid crystal droplet is settled may be easily controlled, and a positional error of the droplet may be reduced. Therefore, a uniform liquid crystal layer may be formed on the substrate or between two substrates.

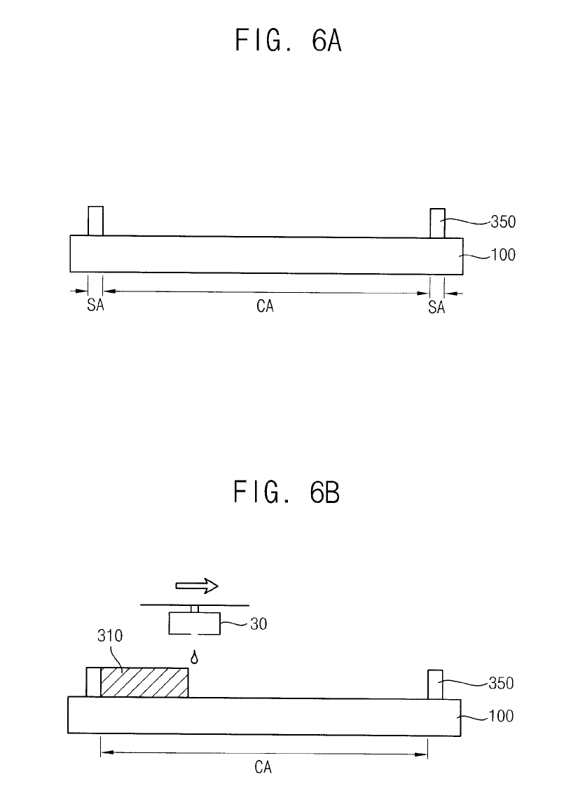

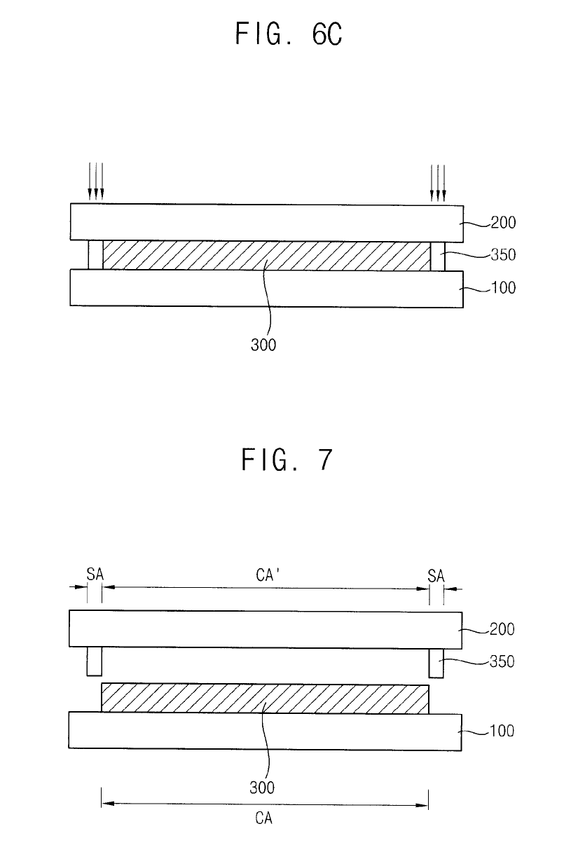

FIG. 6A, FIG. 6B, and FIG. 6C are cross-sectional views describing a method of manufacturing an LCD panel using the method of forming the liquid crystal layer described with reference to FIG. 1 and FIG. 2.

Referring to FIG. 6A, a seal line 350 for sealing liquid crystal is formed at a seal line area SA on a first substrate 100. Although not illustrated in FIG. 6A, the first substrate 100 may include a pixel electrode (not illustrated) and an alignment layer (not illustrated) formed in a liquid crystal area CA. The seal line area SA is defined as an area surrounding the liquid crystal area CA, and the liquid crystal area CA is an area in which a liquid crystal layer is to be formed. The first substrate 100 may further include a switching element, a plurality of wires, an insulation layer, a driving circuit, a color filter, etc.

Referring to FIG. 6B, a liquid crystal material 310 having a reciprocal (Z⁻¹) of the Ohnesorge number in a range of 4≦Z⁻¹≦14 is coated on the first substrate 100 having the seal line 350 by an ink-jet printing method. The liquid crystal material 310 may be coated on an entire of the liquid crystal area CA, however, aspects are not limited thereto. The liquid crystal material 310 may be coated by the ink-jet coating apparatus illustrated in FIG. 1.

When the liquid crystal material 310 is coated on the first substrate 100 by the ink-jet printing method, the reciprocal (Z⁻¹) of the Ohnesorge number may be controlled by a temperature of the liquid crystal material 310. For example, the temperature of the liquid crystal material supplied to the ink-jet head 30 may be controlled. In order to maintain the temperature of the first substrate 100 at a predetermined temperature until the liquid crystal material 310 is coated on a desired portion of or the entirety of the liquid crystal area CA, the first substrate 100 may be heated by a heater.

The ink-jet head 30 moves over the first substrate 100 to coat the first substrate 100 with the liquid crystal material 310 in FIG. 6B. Alternatively, the ink-jet head 30 is fixed, and the first substrate 100 is moved.

Referring to FIG. 6C, a second substrate 200 is disposed on the first substrate 100 on which a liquid crystal layer 300 formed by the ink-jet printing method is disposed. The first substrate 100 and the second substrate 200 facing the first substrate 100 are combined. For example, while the second substrate 200 is disposed on the first substrate 100 including the seal line 350, the seal line 350 may be cured to combine the two substrates 100 and 200. When the first substrate 100 and the second substrate 200 are combined, the LCD panel described in FIG. 2 may be completed.

Although the liquid crystal layer 300 is formed on the first substrate 100 in the method of manufacturing the LCD panel described with reference to FIG. 6A, FIG. 6B, and FIG. 6C, aspects of the invention are not limited thereto. Alternatively, the liquid crystal layer 300 may be formed on the second substrate 200.

FIG. 7 is a cross-sectional view describing a method of manufacturing an LCD panel in accordance with aspects of the invention. The method of manufacturing an LCD panel described with reference to FIG. 7 may be substantially the same as the method described with reference to FIG. 6A, FIG. 6B, and FIG. 6C except that a seal line 350 is formed on the second substrate 200. Therefore, the same reference numbers are used for the same or similar elements, and any further descriptions concerning the same or similar elements as those shown in FIG. 6A and FIG. 6B will be omitted.

Referring to FIG. 7, liquid crystal having a reciprocal (Z⁻¹) of the Ohnesorge number in a range of 4≦Z⁻¹≦14 is coated on the first substrate 100 by an ink-jet printing method to form a liquid crystal layer 300 at a first liquid crystal area CA of the first substrate 100. The liquid crystal layer 300 may be coated on a desired portion or an entirety of the first liquid crystal area CA. The liquid crystal layer 300 may be coated by the ink-jet coating apparatus illustrated in FIG. 1.

In this exemplary embodiment, a seal line 350 is formed at a seal line area SA on a second substrate 200. The seal line area SA of the second substrate 200 surrounds a second liquid crystal area CA′. The second liquid crystal area CA′ is defined as an area of the second substrate 200 facing the first liquid crystal area CA of the first substrate 100.

The second substrate 200 including the seal line 350 is aligned with the first substrate 100 including the liquid crystal layer 300. The first substrate 100 and the second substrate 200 are combined so that the seal line 350 of the second substrate 200 surrounds the liquid crystal layer 300 of the first substrate 100. For example, while the second substrate 200 including the seal line 350 is disposed on the first substrate 100 including the liquid crystal layer 300, the seal line 350 may be cured to combine the two substrates 100 and 200.

Similarly to the method of manufacturing the LCD panel, when the liquid crystal layer is formed by the ink-jet printing method with the liquid crystal having the reciprocal (Z⁻¹) of the Ohnesorge number in a range of 4≦Z¹≦14, a stain may be prevented from appearing in the liquid crystal layer without an additional process, such as a baking process. Furthermore, the position where the liquid crystal droplet is settled may be easily controlled, and a positional error of the droplet may be reduced. Therefore, a uniform liquid crystal layer may be formed on the substrate or between the two substrates.

The foregoing is illustrative of the present disclosure and is not to be construed as limiting thereof. Although a few exemplary embodiments of the invention have been described, those skilled in the art will readily appreciate that many modifications are possible in the exemplary embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific exemplary embodiments disclosed, and that modifications to the disclosed exemplary embodiments, as well as other exemplary embodiments, are intended to be included within the scope of the appended claims.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of forming a liquid crystal layer, the method comprising:
forming a liquid crystal layer by coating a liquid crystal material having a reciprocal (Z⁻¹) of an Ohnesorge number in a range of 4≦Z⁻¹≦14 by an ink-jet printing method,
wherein the reciprocal (Z⁻¹) of the Ohnesorge number is a dimensionless number defined as Z⁻¹=([σρL]^{1/2})/μ,
wherein σ represents a coefficient of a surface tension of the liquid crystal material, which has units of Newtons per meter (N/m),
wherein ρ represents a density of the liquid crystal material, which has units of kilograms per cubic meter (kg/m³),
wherein L represents a diameter of a liquid crystal material droplet formed in the ink-jet printing method, which has units of meters (m), and
wherein μ represents a coefficient of a viscosity of the liquid crystal material, which has units of Pascal-seconds (Pa·s).

2. The method of claim 1, further comprising controlling a temperature of the liquid crystal material to manipulate the reciprocal (Z⁻¹) of the Ohnesorge number.

3. The method of claim 2, wherein the temperature of the liquid crystal material is controlled to be in a range of 20° C. to 40° C.

4. The method of claim 3, wherein the coefficient of a surface tension (σ) of the liquid crystal material is in a range of 47.8×10⁻³ N/m to 49.5×10⁻³ N/m.

5. The method of claim 4, wherein the coefficient of a viscosity (μ) of the liquid crystal material is in a range of 3.3×10⁻³ Pa·s to 10.2×10⁻³ Pa·s.

6. The method of claim 5, wherein the density (ρ) of the liquid crystal material is in a range of 1,068 kg/m³ to 1,088 kg/m³.

7. The method of claim 6, wherein the diameter of the liquid crystal material droplet is 50 μm.

8. A method of manufacturing a liquid crystal display panel, the method comprising:
coating a liquid crystal material having a reciprocal (Z⁻¹) of an Ohnesorge number in a range of 4≦Z⁻¹≦14 on a first substrate by an ink-jet printing method; and
combining the first substrate and a second substrate,
wherein the reciprocal (Z⁻¹) of the Ohnesorge number is a dimensionless number defined as Z⁻¹=([σρL]^{1/2})/μ,
wherein σ represents a coefficient of a surface tension of the liquid crystal material, which has units of Newtons per meter (N/m),
wherein ρ represents a density of the liquid crystal material, which has units of kilograms per cubic meter (kg/m³),
wherein L represents a diameter of a liquid crystal material droplet formed in the ink-jet printing method, which has units of meters (m), and
wherein μ represents a coefficient of a viscosity of the liquid crystal material, which has units of Pascal-seconds (Pa·s).

9. The method of claim 8, further comprising controlling a temperature of the liquid crystal material to manipulate the reciprocal (Z⁻¹) of the Ohnesorge number.

10. The method of claim 9, wherein the temperature of the liquid crystal material is controlled to be in a range of 20° C. to 40° C.

11. The method of claim 10, wherein the coefficient of the surface tension (σ) of the liquid crystal material is in a range of 47.8×10⁻³ N/m to 49.5×10⁻³ N/m.

12. The method of claim 11, wherein the coefficient of the viscosity (μ) of the liquid crystal material is in a range of 3.3×10⁻³ Pa·s to 10.2×10⁻³ Pa·s.

13. The method of claim 12, wherein the density (ρ) of the liquid crystal material is in a range of 1,068 kg/m³ to 1,088 kg/m³.

14. The method of claim 13, wherein the diameter of the liquid crystal material droplet is 50 μm.

15. The method of claim 8, wherein the liquid crystal material is coated on a first area of the first substrate, and
wherein the combining of the first substrate and the second substrate comprises:
forming a seal line at a second area of the first substrate, the second area of the first substrate surrounding the first area of the first substrate;
disposing the second substrate on the first substrate having the seal line; and
curing the seal line.

16. The method of claim 8, wherein the liquid crystal material is coated on a first area of the first substrate, and
wherein the combining of the first substrate and the second substrate comprises:
forming a seal line at a second area of the second substrate, the second area of the second substrate surrounding a first area of the second substrate, the first area of the second substrate facing the first area of the first substrate;
disposing the second substrate having the seal line on the first substrate; and
curing the seal line.

17. A liquid crystal material used as a raw material for forming a liquid crystal layer by an ink-jet printing method, wherein the liquid crystal material has a reciprocal (Z⁻¹) of an Ohnesorge number in a range of 4≦Z¹≦14,
wherein the reciprocal (Z⁻¹) of the Ohnesorge number is a dimensionless number defined as Z⁻¹=([σρL]^{1/2})/μ,
wherein σ represents a coefficient of a surface tension of the liquid crystal material, which has units of Newtons per meter (N/m),
wherein ρ represents a density of the liquid crystal material, which has units of kilograms per cubic meter (kg/m³),
wherein L represents a diameter of a liquid crystal material droplet formed in the ink-jet printing method, which has units of meters (m), and
wherein μ represents a coefficient of a viscosity of the liquid crystal material, which has units of Pascal-seconds (Pa·s).

18. The liquid crystal of claim 17, wherein the coefficient of viscosity (μ) of the liquid crystal material is in a range of 3.3×10⁻³ Pa·s to 10.2×10⁻³ Pa·s.

19. The liquid crystal of claim 17, wherein the density (ρ) of the liquid crystal material is in a range of 1,068 kg/m³ to 1,088 kg/m³.

20. The liquid crystal of claim 17, wherein the coefficient of a surface tension (σ) of the liquid crystal material is in a range of 47.8×10⁻³ N/m to 49.5×10⁻³ N/m.
